(19) United States
(12) Patent Application Publication
(10) Pub. No.: US 2025/0132102 A1
(43) Pub. Date: Apr. 24, 2025

(54) Supercapacitor

(71) Applicant: KYOCERA AVX Components (Chengdu) Co., Ltd, Chengdu, Sichuan (CN)

(72) Inventor: Fanghui Zhao, Chengdu, Sichuan (CN)

(21) Appl. No.: 18/836,428

(22) PCT Filed: Feb. 7, 2023
(86) PCT No.: PCT/CN2023/074813

§ 371 Date: Aug. 7, 2024

(30) Foreign Application Priority Data
Feb. 7, 2022 (CN) 202210116314.2

(51) Int. Cl. H01G 11/30; H01G 11/80; H01G 11/84

(52) U.S. Cl. CPC H01G 11/30; H01G 11/80; H01G 11/84

(57) ABSTRACT

The present application discloses a supercapacitor. The supercapacitor comprises: a capacitor element comprising a positive electrode, a negative electrode, and a separator interposed between the positive electrode and the negative electrode; an electrolyte impregnating the capacitor element; a housing for accommodating the capacitor element and the electrolyte; and a sealing member for sealing an opening portion of the housing, the sealing member being provided with a through hole for respectively allowing a guide pin of the positive electrode and a guide pin of the negative electrode to be inserted in, wherein at least part of the surface of an aluminum stem, located in the through hole, in the guide pin of the negative electrode is covered with a polymer coating. The present application further discloses a method for forming the supercapacitor and a use of the polymer coating coated on the surface of the aluminum stem in the guide pin of the negative electrode in suppressing alkali creep of the negative electrode in the supercapacitor.

### FIELD OF THE INVENTION

The present application relates to a supercapacitor, a method for forming the supercapacitor, and a use of a polymer coating coated on the surface of an aluminum stem in a guide pin of a negative electrode in suppressing alkali creep of the negative electrode in the supercapacitor.

### BACKGROUND ART

Supercapacitors generally use electrolytes as solutions of organic ammonium salts. According to the basic principle of supercapacitors: when a supercapacitor is being charged, positively charged ammonium ions (basic) move to the surface of the negative electrode, forming a double-layer capacitor. Continuous application of voltage and high temperature will accelerate the formation of some highly basic substances. These highly basic substances easily move on the metal surface, commonly known as “alkali creep.” In conventional guide pin-type capacitors, the sealing of a guide pin hole relies solely on the deformation of the rubber plug caused by the waist constriction of the aluminum shell to press the aluminum stem of the guide pin. The basic substances formed at the negative electrode may leak outside the capacitor along the aluminum stem of the guide pin. This causes the pH value at the solder joints and leads to rise to around 11, leading to corrosion. More seriously, when the basic substances absorb moisture, they form a conductive alkaline solution, which flows onto the circuit board soldered to the capacitor, corroding the circuit board and causing a short circuit.

Therefore, it is highly necessary to develop a novel supercapacitor that can effectively suppress alkali creep of the negative electrode.

### SUMMARY OF THE INVENTION

To address the above-described problem, a first aspect of the present application provides a supercapacitor, which includes:
a capacitor element comprising a positive electrode, a negative electrode, and a separator interposed between the positive electrode and the negative electrode;
an electrolyte impregnating the capacitor element;
a housing for accommodating the capacitor element and the electrolyte; and
a sealing member for sealing an opening portion of the housing, the sealing member being provided with a through hole for respectively allowing a guide pin of the positive electrode and a guide pin of the negative electrode to be inserted in;
wherein at least part of the surface of an aluminum stem, located in the through hole, in the guide pin of the negative electrode is covered with a polymer coating.

A second aspect of the present application provides a method for forming a supercapacitor, the method comprising:
forming a polymer coating on at least part of the surface of an aluminum stem in a guide pin of a negative electrode; and
inserting the guide pin of the negative electrode into a through hole, so that the aluminum stem in the guide pin of the negative electrode is located inside the through hole and fits closely with the inner wall of the through hole.

A third aspect of the present application provides a use of a polymer coating coated on the surface of an aluminum stem in a guide pin of a negative electrode in suppressing alkali creep of the negative electrode in a supercapacitor.

In a preferred implementation, the polymer coating involved in the above-described first aspect, second aspect, and third aspect is formed by a polymer adhesive.

The present application changes the surface state of the metallic aluminum by covering the surface of the aluminum stem in the guide pin of the negative electrode with a polymer coating, so that the movement of alkaline substances on the aluminum surface is slowed, thereby effectively suppressing alkali creep and alleviating leakage at the guide pin of the negative electrode of the capacitor.

### BRIEF DESCRIPTION OF THE DRAWINGS

FIG. 1 is a schematic structural diagram of a supercapacitor in Embodiment 1 of the present application.

FIG. 2 is a schematic structural diagram of a guide pin of the positive electrode and a guide pin of the negative electrode of the supercapacitor in Embodiment 1 of the present application.

FIG. 3 is a schematic structural diagram of an adhesive-coated guide pin in Embodiment 1 of the present application.

### DETAILED DESCRIPTION OF THE INVENTION

The content of the present invention can be more easily understood with reference to the detailed description of preferred implementations of the present application below and the embodiments comprised therein.

Unless otherwise defined, all technical and scientific terms used herein have the same meaning as commonly understood by one of ordinary skill in the art to which the present application belongs. In case of any conflict, the definitions provided in this specification shall prevail.

The terms “comprise,” “include,” “have,” “contain,” or any other variations thereof are intended to cover a non-exclusive inclusion.

When an equivalent, a concentration, or other values or parameters are given as a range, a preferred range, or ranges defined by a series of upper limit preferred values and lower limit preferred values, it should be understood as specifically disclosing all ranges formed by any pairing of any range upper limit or preferred value with any range lower limit or preferred value, regardless of whether such a range is separately disclosed. For example, when a range of “1 to 5” is disclosed, it should be interpreted as including the ranges “1 to 4,” “1 to 3,” “1 to 2,” “1 to 2 and 4 to 5,” “1 to 3 and 5,” and the like. When a numerical range is described herein, the range is intended to include its endpoints and all integers and fractions within that range, unless otherwise specified.

Moreover, the indefinite articles “a” and “an” preceding elements or components in the present application do not limit the quantity (i.e., the number of occurrences) of the elements or components. Therefore, “a” or “an” should be interpreted as including one or at least one, and singular forms of elements or components also include plural forms unless the quantity clearly indicates a singular form.

The term “guide pin” as used in the present application includes a lead, an aluminum stem, and an aluminum tongue, wherein the lead is soldered to one end of the aluminum stem, and the other end of the aluminum stem is connected to the aluminum tongue. In the present application, as conventionally used in the prior art, the guide pin of the positive electrode and the guide pin of the negative electrode are set in such a way that when inserted into the through hole, the aluminum stem is located inside the through hole and fits closely with the inner wall of the through hole.

The term “polymer coating” as used in the present application refers to a coating formed by applying an organic polymer on the surface of a substrate.

The term “polymer adhesive” as used in the present application refers to an adhesive material made with a natural or synthetic polymer compound as the main part.

The term “thermosetting resin adhesive” as used in the present application refers to an adhesive that uses a thermosetting resin containing reactive groups as the adhesive material. When a curing agent is added or heat is applied, the molecules of the liquid adhesive material may further be polymerized and crosslinked into a three-dimensional network structure, forming an insoluble and infusible solid adhesive layer to achieve the goal of bonding. It can be cured at room temperature or by heating, with the former referred to as the room-temperature curing type adhesive and the latter as the heat-curing type adhesive.

The term “photo-curing resin adhesive” as used in the present application refers to a resin adhesive that quickly cures under light exposure to achieve the goals such as bonding, sealing, and fixing.

The term “epoxy resin adhesive” as used in the present application refers to an adhesive prepared using epoxy resin as the base material.

The term “polyurethane adhesive” as used in the present application refers to an adhesive prepared using polyurethane as the base material.

### Capacitor

The first aspect of the present application provides a supercapacitor, which includes:
a capacitor element comprising a positive electrode, a negative electrode, and a separator interposed between the positive electrode and the negative electrode;
an electrolyte impregnating the capacitor element;
a housing for accommodating the capacitor element and the electrolyte; and
a sealing member for sealing an opening portion of the housing, the sealing member being provided with a through hole for respectively allowing a guide pin of the positive electrode and a guide pin of the negative electrode to be inserted in;
wherein at least part of the surface of an aluminum stem, located in the through hole, in the guide pin of the negative electrode is covered with a polymer coating.

By covering at least part of the surface of the aluminum stem in the guide pin of the negative electrode with a polymer coating, the surface state of the metallic aluminum may be changed, and the movement of alkaline substances on the aluminum surface may be slowed, thereby effectively suppressing alkali creep. Specifically, by using the polymer coating, the supercapacitor according to the present application will not have alkali creep within 4,000 hours at 65° C. and a constant voltage of 2.7 V.

In one implementation, a polymer coating is coated on the surface that accounts for 50%-100% of the area of the aluminum stem in the guide pin of the negative electrode. For example, the polymer coating may be coated on the surface that accounts for an area of the aluminum stem in the guide pin of the negative electrode that is selected from the following group: 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100%. To achieve the optimal effect in suppressing alkali creep, preferably, the polymer coating is coated on the surface that accounts for 100% of the area of the aluminum stem in the guide pin of the negative electrode.

In one implementation, the thickness of the polymer coating is 5-30 μm, preferably 10-20 μm. For example, an optional thickness of the polymer coating is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, and 30 μm, preferably 10 μm, 11 μm, 12 μm, 13 μm, 14 μm, 15 μm, 16 μm, 17 μm, 18 μm, 19 μm, and 20 μm.

In one implementation, the polymer coating is resistant to electrolytes and/or resistant to bases with PH 7-14 and/or resistant to temperatures in the range of −40° C.-180° C. and/or resistant to water. Specifically, the polymer coating does not fall off after being immersed in an electrolyte or a basic solution with PH 7-14 for 72 hours.

In one implementation, the polymer coating is formed by a polymer adhesive.

In one implementation, the polymer adhesive is selected from resin adhesives and/or rubber adhesives.

In one implementation, the resin adhesive is selected from thermosetting resin adhesives and/or photo-curing resin adhesives. Preferably, photo-curing resin adhesives that can be used in the present application are selected from the following group of Loctite 3106, Loctite 3311, Loctite 3623, Loctite 3103, or Loctite 3321.

In one implementation, the resin adhesive is selected from epoxy resin adhesives and/or polyurethane adhesives.

In one implementation, the rubber adhesive is selected from the following group of butyl rubber adhesives, silicone rubber adhesives, and fluororubber adhesives.

### A Method for Forming a Supercapacitor

The second aspect of the present application provides a method for forming a supercapacitor, the method comprising:
forming a polymer coating on at least part of the surface of an aluminum stem in a guide pin of a negative electrode; and
inserting the guide pin of the negative electrode into a through hole, so that the aluminum stem in the guide pin of the negative electrode is located inside the through hole and fits closely with the inner wall of the through hole.

In one implementation, a polymer coating is coated on the surface that accounts for 50%-100% of the area of the aluminum stem in the guide pin of the negative electrode. For example, the polymer coating may be coated on the surface that accounts for an area of the aluminum stem in the guide pin of the negative electrode that is selected from the following group: 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100%. Preferably, the polymer coating is coated on the surface that accounts for 100% of the area of the aluminum stem in the guide pin of the negative electrode.

In one implementation, the thickness of the polymer coating is 5-30 μm, preferably 10-20 μm. For example, an optional thickness of the polymer coating is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, and 30 μm, preferably 10 μm, 11 μm, 12 μm, 13 μm, 14 μm, 15 μm, 16 μm, 17 μm, 18 μm, 19 μm, and 20 μm.

In one implementation, the polymer coating is resistant to electrolytes and/or resistant to bases with PH 7-14 and/or resistant to temperature in the range of −40° C. to 180° C. and/or resistant to water. Specifically, the polymer coating does not fall off after being immersed in an electrolyte or a basic solution with PH 7-14 for 72 hours.

In one implementation, the polymer coating is formed by a polymer adhesive.

In one implementation, the polymer adhesive is selected from resin adhesives and/or rubber adhesives.

In one implementation, the resin adhesive is selected from thermosetting resin adhesives and/or photo-curing resin adhesives. Preferably, photo-curing resin adhesives that can be used in the present application are selected from the following group of Loctite 3106, Loctite 3311, Loctite 3623, Loctite 3103, or Loctite 3321.

In one implementation, the resin adhesive is selected from epoxy resin adhesives and/or polyurethane adhesives.

In one implementation, the rubber adhesive is selected from the following group of butyl rubber adhesives, silicone rubber adhesives, and fluororubber adhesives.

In one implementation, the forming of a polymer coating is realized by uniformly spraying through a coating guide pin.

### A Use of a Polymer Coating

The third aspect of the present application provides a use of a polymer coating coated on the surface of an aluminum stem in a guide pin of a negative electrode in suppressing alkali creep of the negative electrode in a supercapacitor.

In one implementation, the polymer coating is coated on the surface that accounts for 50%-100% of the area of the aluminum stem in the guide pin of the negative electrode. For example, the polymer coating may be coated on the surface that accounts for an area of the aluminum stem in the guide pin of the negative electrode that is selected from the following group: 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, and 100%. Preferably, the polymer coating is coated on the surface that accounts for 100% of the area of the aluminum stem in the guide pin of the negative electrode.

In one implementation, the thickness of the polymer coating is 5-30 μm, preferably 10-20 μm. For example, an optional thickness of the polymer coating is 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, and 30 μm, preferably 10 μm, 11 μm, 12 μm, 13 μm, 14 μm, 15 μm, 16 μm, 17 μm, 18 μm, 19 μm, and 20 μm.

In one implementation, the polymer coating is resistant to electrolytes and/or resistant to bases with PH 7-14 and/or resistant to temperature in the range of −40° C.-180° C. and/or resistant to water. Specifically, the polymer coating being resistant to electrolytes and/or resistant to bases with PH 7-14 refers to that the polymer coating does not fall off after being immersed in an electrolyte or a basic solution with PH 7-14 for 72 hours.

In one implementation, the polymer coating is formed by a polymer adhesive.

In one implementation, the polymer adhesive is selected from resin adhesives and/or rubber adhesives.

In one implementation, the resin adhesive is selected from thermosetting resin adhesives and/or photo-curing resin adhesives. Preferably, photo-curing resin adhesives that can be used in the present application are selected from the following group of Loctite 3106, Loctite 3311, Loctite 3623, Loctite 3103, or Loctite 3321.

In one implementation, the resin adhesive is selected from epoxy resin adhesives and/or polyurethane adhesives.

In one implementation, the rubber adhesive is selected from the following group of butyl rubber adhesives, silicone rubber adhesives, and fluororubber adhesives.

The present application comprises the following implementations:

Implementation 1. A supercapacitor, which includes:
a capacitor element comprising a positive electrode, a negative electrode, and a separator interposed between the positive electrode and the negative electrode;
an electrolyte impregnating the capacitor element;
a housing for accommodating the capacitor element and the electrolyte; and
a sealing member for sealing an opening portion of the housing, the sealing member being provided with a through hole for respectively allowing a guide pin of the positive electrode and a guide pin of the negative electrode to be inserted in;
wherein at least part of the surface of an aluminum stem, located in the through hole, in the guide pin of the negative electrode is covered with a polymer coating.

Implementation 2. The supercapacitor according to Implementation 1, wherein the supercapacitor does not have alkali creep within 4,000 hours at 65° C. and a constant voltage of 2.7 V.

Implementation 3. The supercapacitor according to Implementation 1 or 2, wherein a polymer coating is coated on the surface that accounts for 50%-100% of the area of the aluminum stem in the guide pin of the negative electrode.

Implementation 4. The supercapacitor according to Implementation 3, wherein a polymer coating is coated on the surface that accounts for 100% of the area of the aluminum stem in the guide pin of the negative electrode.

Implementation 5. The supercapacitor according to Implementation 1 or 2, wherein the thickness of the polymer coating is 5-30 μm.

Implementation 6. The supercapacitor according to Implementation 5, wherein the thickness of the polymer coating is 10-20 μm.

Implementation 7. The supercapacitor according to Implementation 1 or 2, wherein the polymer coating is resistant to electrolytes and/or resistant to bases with PH 7-14 and/or resistant to temperature in the range of −40° C.-180° C. and/or resistant to water.

Implementation 8. The supercapacitor according to Implementation 1 or 2, wherein the polymer coating does not fall off after being immersed in an electrolyte or a basic solution with PH 7-14 for 72 hours.

Implementation 9. The supercapacitor according to Implementation 1 or 2, wherein the polymer coating is formed by a polymer adhesive.

Implementation 10. The supercapacitor according to Implementation 9, wherein the polymer adhesive is selected from resin adhesives and/or rubber adhesives.

Implementation 11. The supercapacitor according to Implementation 10, wherein the resin adhesive is selected from thermosetting resin adhesives and/or photo-curing resin adhesives; and preferably, the photo-curing resin adhesive is selected from the following group of Loctite 3106, Loctite 3311, Loctite 3623, Loctite 3103, or Loctite 3321.

Implementation 12. The supercapacitor according to Implementation 10, wherein the resin adhesive is selected from epoxy resin adhesives and/or polyurethane adhesives.

Implementation 13. The supercapacitor according to Implementation 10, wherein the rubber adhesive is selected from the following group of butyl rubber adhesives, silicone rubber adhesives, and fluororubber adhesives.

Implementation 14. A method for forming a supercapacitor, wherein the method comprises:
forming a polymer coating on at least part of the surface of an aluminum stem in a guide pin of a negative electrode; and
inserting the guide pin of the negative electrode into a through hole, so that the aluminum stem in the guide pin of the negative electrode is located inside the through hole and fits closely with the inner wall of the through hole.

Implementation 15. The method according to Implementation 14, wherein a polymer coating is formed on the surface that accounts for 50%-100% of the area of the aluminum stem in the guide pin of the negative electrode.

Implementation 16. The method according to Implementation 15, wherein a polymer coating is formed on the surface that accounts for 100% of the area of the aluminum stem in the guide pin of the negative electrode.

Implementation 17. The method according to Implementation 14 or 15, wherein the thickness of the polymer coating is 5-30 μm.

Implementation 18. The method according to Implementation 17, wherein the thickness of the polymer coating is 10-20 μm.

Implementation 19. The method according to Implementation 14 or 15, wherein the polymer coating is resistant to electrolytes and/or resistant to bases with PH 7-14 and/or resistant to temperature in the range of −40° C.-180° C. and/or resistant to water.

Implementation 20. The method according to Implementation 14 or 15, wherein the polymer coating does not fall off after being immersed in an electrolyte or a basic solution with PH 7-14 for 72 hours.

Implementation 21. The method according to Implementation 14 or 15, wherein the polymer coating is formed by a polymer adhesive.

Implementation 22. The method according to Implementation 21, wherein the polymer adhesive is selected from resin adhesives and/or rubber adhesives.

Implementation 23. The method according to Implementation 22, wherein the resin adhesive is selected from thermosetting resin adhesives and/or photo-curing resin adhesives; and preferably, the photo-curing resin adhesive is selected from the following group of Loctite 3106, Loctite 3311, Loctite 3623, Loctite 3103, or Loctite 3321.

Implementation 24. The method according to Implementation 22, wherein the resin adhesive is selected from epoxy resin adhesives and/or polyurethane adhesives.

Implementation 25. The method according to Implementation 22, wherein the rubber adhesive is selected from the following group of butyl rubber adhesives, silicone rubber adhesives, and fluororubber adhesives.

Implementation 26. The method according to Implementation 14 or 15, wherein the forming of a polymer coating is realized by uniformly spraying through a coating guide pin.

Implementation 27. A use of a polymer coating coated on the surface of an aluminum stem in a guide pin of a negative electrode in suppressing alkali creep of the negative electrode in a supercapacitor.

Implementation 28. The use according to Implementation 27, wherein the polymer coating is coated on the surface that accounts for 50%-100% of the area of the aluminum stem in the guide pin of the negative electrode.

Implementation 29. The use according to Implementation 28, wherein the polymer coating is coated on the surface that accounts for 100% of the area of the aluminum stem in the guide pin of the negative electrode.

Implementation 30. The use according to Implementation 27 or 28, wherein the thickness of the polymer coating is 5-30 μm.

Implementation 31. The use according to Implementation 30, wherein the thickness of the polymer coating is 10-20 μm.

Implementation 32. The use according to Implementation 27 or 28, wherein the polymer coating is resistant to electrolytes and/or resistant to bases with PH 7-14 and/or resistant to temperature in the range of −40° C.-180° C. and/or resistant to water.

Implementation 33. The use according to Implementation 27 or 28, wherein the polymer coating does not fall off after being immersed in an electrolyte or a basic solution with PH 7-14 for 72 hours.

Implementation 34. The use according to Implementation 27 or 28, wherein the polymer coating is formed by a polymer adhesive.

Implementation 35. The use according to Implementation 27 or 28, wherein the polymer adhesive is selected from resin adhesives and/or rubber adhesives.

Implementation 36. The use according to Implementation 35, wherein the resin adhesive is selected from thermosetting resin adhesives and/or photo-curing resin adhesives; and preferably, the photo-curing resin adhesive is selected from the following group of Loctite 3106, Loctite 3311, Loctite 3623, Loctite 3103, or Loctite 3321.

Implementation 37. The use according to Implementation 35, wherein the resin adhesive is selected from epoxy resin adhesives and/or polyurethane adhesives.

Implementation 38. The use according to Implementation 35, wherein the rubber adhesive is selected from the following group of butyl rubber adhesives, silicone rubber adhesives, and fluororubber adhesives.

### PREFERRED EMBODIMENTS

The preferred embodiments of the present application will be further described in detail below with reference to the accompanying drawings. The description below is illustrative instead of limitation to the present application, and another other similar scenarios shall all fall within the scope of protection of the present application.

### Embodiment 1

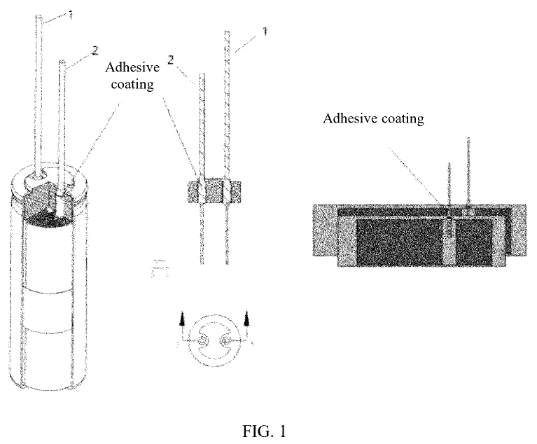

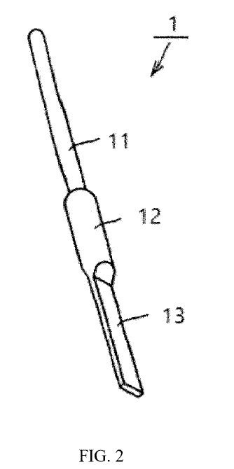

Referring to FIG. 1, the supercapacitor in the present embodiment includes:
a capacitor element comprising a positive electrode, a negative electrode, and a separator interposed between the positive electrode and the negative electrode;
an electrolyte impregnating the capacitor element;
a housing for accommodating the capacitor element and the electrolyte; and
a sealing member for sealing an opening portion of the housing, the sealing member being provided with a through hole for respectively allowing a guide pin 1 of the positive electrode and a guide pin 2 of the negative electrode to be inserted in;
the guide pin of the positive electrode and the guide pin of the negative electrode include a lead 11, an aluminum stem 12, and an aluminum tongue 13 (wherein the lead is soldered to one end of the aluminum stem, and the other end of the aluminum stem is connected to the aluminum tongue, referring to FIG. 2), and are set in such a way that when inserted into the through hole, the aluminum stem is located inside the through hole and fits closely with the inner wall of the through hole; and the surface of the aluminum stem in the guide pin of the negative electrode is fully covered with a polymer coating.

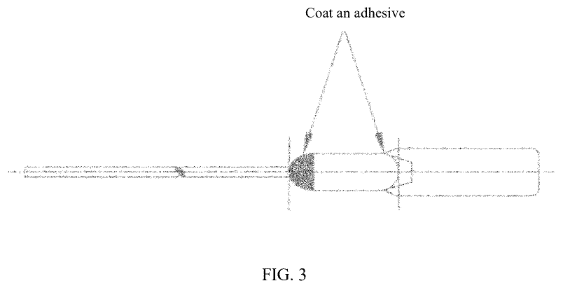

The in which the polymer coating is formed includes: uniformly spraying a polymer adhesive (Loctite 3106 light-cure acrylic adhesive) through a coating guide pin (see FIG. 3 for the structure) on the surface of the aluminum stem in the guide pin of the negative electrode, so as to form a 16 μm-thick polymer coating.

### Reference Example 1

Same as Embodiment 1 with the only difference in that no polymer coating is coated on the surface of the aluminum stem in the guide pin of the negative electrode.

### Testing Results

Take 10 of the supercapacitor of Embodiment 1 and 10 of the supercapacitor of Reference Example 1. Place these samples at 65° C. and a constant voltage of 2.7 V at the same time, and observe the number of samples that have alkali creep of the negative electrode at 3,000 hours, 4,000 hours, 5,000 hours, 6,000 hours, 7,000 hours, and 8,000 hours, respectively.

The testing results are shown in the table below:

| | 3,000 h | 4,000 h | 5,000 h | 6,000 h | 7,000 h | 8,000 h |
|---|---|---|---|---|---|---|
| The number of samples that have | 0 | 0 | 1 | 2 | 3 | 5 |
| alkali creep of the negative | | | | | | |
| electrode in the 10 samples of | | | | | | |
| Embodiment 1 | | | | | | |
| The number of samples that have | 0 | 2 | 4 | 7 | 8 | 10 |
| alkali creep of the negative | | | | | | |
| electrode in the 10 samples of | | | | | | |
| Reference Example 1 | | | | | | |

As can be seen from Table 1 above that no alkali creep phenomenon occurs within 4,000 h in the supercapacitor samples of Embodiment 1, and only 1 case of alkali creep occurs between 4,000-5,000 h (i.e., alkali creep occurs in 10% of the samples). However, for the supercapacitor samples of Reference Example 1, 2 cases of alkali creep occur between 3,000-4,000 h, and 4 cases of alkali creep occur between 4,000-5,000 h (i.e., alkali creep occurs in 40% of the samples). Furthermore, when the test reaches 8,000 h, alkali creep occurs in all the supercapacitor samples of Reference Example 1, while there are still 5 supercapacitor samples of Embodiment 1 that do not have alkali creep (i.e., 50% of the samples do not have alkali creep). Such results show that the present application obtains a novel supercapacitor that can effectively suppress alkali creep and achieves significant advantageous technical effects.

### DESCRIPTION OF NUMERALS

1 guide pin of the positive electrode
2 guide pin of the negative electrode
11 lead
12 aluminum stem
13 aluminum tongue.

The examples above are merely illustrative and used to explain some features of features of the present disclosure. The appended claims are intended to claim a scope that is as conceivably broad as possible, and the embodiments presented here in are merely a description of implementations selected according to all possible combinations of embodiments. Therefore, the intention of the applicant is that the appended claims are not limited to the examples for describing the features of the present application. As used in the claims, the term “comprising” and semantic variants thereof also logically comprise different and changing terms, for example, but not limited to “substantially consisting of” or “consisting of.” When necessary, some numerical ranges are provided, and these ranges also include sub-ranges therein. Changes to these ranges are also self-evident to those skilled in the art, and shall not be regarded as being donated to the public, while these changes shall also be interpreted, whenever possible, as being encompassed by the appended claims. In addition, scientific and technical progresses will form possible equivalents or sub-substitutions that are not considered currently due to inaccurate language expressions, and such changes shall also be interpreted, whenever possible, as being encompassed by the appended claims.

1-41. (canceled)

42. A supercapacitor, which includes:
a capacitor element comprising a positive electrode, a negative electrode, and a separator interposed between the positive electrode and the negative electrode;
an electrolyte impregnating the capacitor element;
a housing for accommodating the capacitor element and the electrolyte; and
a sealing member for sealing an opening portion of the housing, the sealing member being provided with a through hole for respectively allowing a guide pin of the positive electrode and a guide pin of the negative electrode to be inserted in;
characterized in that at least part of the surface of an aluminum stem, located in the through hole, in the guide pin of the negative electrode is covered with a polymer coating.

43. The supercapacitor according to claim 42, characterized in that the supercapacitor does not have alkali creep within 4,000 hours at 65° C. and a constant voltage of 2.7 V.

44. The supercapacitor according to claim 42, characterized in that a polymer coating is coated on the surface that accounts for 50%-100% of the area of the aluminum stem in the guide pin of the negative electrode.

45. The supercapacitor according to claim 44, characterized in that a polymer coating is coated on the surface that accounts for 100% of the area of the aluminum stem in the guide pin of the negative electrode.

46. The supercapacitor according to claim 42, characterized in that the thickness of the polymer coating is 5-30 μm.

47. The supercapacitor according to claim 46, characterized in that the thickness of the polymer coating is 10-20 μm.

48. The supercapacitor according to claim 42, characterized in that the polymer coating is resistant to electrolytes and/or resistant to bases with pH 7-14 and/or resistant to temperature in the range of −40° C.-180° C. and/or resistant to water.

49. The supercapacitor according to claim 42, characterized in that the polymer coating does not fall off after being immersed in an electrolyte or a basic solution with pH 7-14 for 72 hours.

50. The supercapacitor according to claim 42, characterized in that the polymer coating is formed by a polymer adhesive.

51. The supercapacitor according to claim 50, characterized in that the polymer adhesive is selected from resin adhesives and/or rubber adhesives.

52. The supercapacitor according to claim 51, characterized in that the resin adhesive is selected from thermosetting resin adhesives and/or photo-curing resin adhesives.

53. The supercapacitor according to claim 51, characterized in that the resin adhesive is selected from epoxy resin adhesives and/or polyurethane adhesives.

54. The supercapacitor according to claim 51, characterized in that the rubber adhesive is selected from the following group of butyl rubber adhesives, silicone rubber adhesives, and fluororubber adhesives.

55. The supercapacitor according to claim 52, characterized in that the photo-curing resin adhesive is selected from the following group of Loctite 3106, Loctite 3311, Loctite 3623, Loctite 3103, or Loctite 3321.

56. A method for forming the supercapacitor of claim 42, characterized in that the method comprises:
forming the polymer coating on at least part of the surface of the aluminum stem in the guide pin of the negative electrode; and
inserting the guide pin of the negative electrode into the through hole, so that the aluminum stem in the guide pin of the negative electrode is located inside the through hole and fits closely with the inner wall of the through hole.

57. The method according to claim 56, characterized in that a polymer coating is coated on the surface that accounts for 50%-100% of the area of the aluminum stem in the guide pin of the negative electrode.

58. The method according to claim 56, characterized in that the thickness of the polymer coating is 5-30 μm.

59. The method according to claim 56, characterized in that the polymer coating is formed by a polymer adhesive selected from resin adhesives and/or rubber adhesives.

60. The method according to claim 59, characterized in that the resin adhesive is selected from thermosetting resin adhesives and/or photo-curing resin adhesives.

61. The method according to claim 59, characterized in that the resin adhesive is selected from epoxy resin adhesives and/or polyurethane adhesives.

62. The method according to claim 59, characterized in that the rubber adhesive is selected from the following group of butyl rubber adhesives, silicone rubber adhesives, and fluororubber adhesives.

63. The method according to claim 56, characterized in that the forming of the polymer coating is realized by uniformly spraying through a coating guide pin.
